(19) United States
(12) Patent Application Publication
(10) Pub. No.: US 2012/0145091 A1
(43) Pub. Date: Jun. 14, 2012

(54) Scented Stuffed Toy and Method for Producing The Same

(76) Inventor: Ping Wang, Tianjin (CN)

(21) Appl. No.: 12/966,034

(22) Filed: Dec. 13, 2010

(51) Int. Cl. A01K 29/00; B29C 44/12

(52) U.S. Cl. 119/711; 264/45.3

(57) ABSTRACT

A scented stuffed toy has a latex body formed to define an exterior appearance and having a chamber therein, a scented material being scented and mounted inside the chamber, and a PU stuffing formed by polyurethane foam, fully filled in the chamber and adhered to an inner wall of the latex body. A method for producing a scented stuffed toy has a mold preparing step, a latex injecting step, a polyurethane filling step, a scented material adding step, a foaming step and a demolding step. As the PU stuffing is combined with the scented material and foamed inside the latex body, the present invention emits a scent and attracts the sense of smell of pets so that pets can play with the scented stuffed toy with more fun.

### BACKGROUND OF THE INVENTION

1. Field of the Invention

The present invention relates to a stuffed toy, and more particularly to a stuffed toy having a scented stuffing and a resilient body receiving the stuffing therein, and a method for producing the stuffed toy.

2. Description of the Related Art

Stuffed toys are soft throughout, resilient and squeezable and can be used as toys for pets to play with and chew.

With reference to FIG. 4, a conventional stuffed toy has a resilient body 41 and a core 42. The resilient body 41 is formed by latex and the core 42 is formed by artificial cotton fibers. The stuffed toy has an embedded whistle 43. When the conventional stuffed toy is pressed or released, air is forced through the embedded whistle 43 so making a squeaking sound. The cuddly, chewable and audible stuffed toys attract pets. However, the resilient bodies 41 and the cores 42 of the conventional stuffed toys are odorless, so the stuffed toys having no smell to lure pets are difficult to keep stimulating and attracting pets for chewing and playing. Accordingly, the conventional stuffed toy requires further refinement.

### SUMMARY OF THE INVENTION

A first objective of the present invention is to provide a scented stuffed toy having a scented stuffing and a resilient body receiving the stuffing therein.

To achieve the foregoing objective, the safety stuffed toy has a latex body, a scented material and a stuffing. The latex body is formed to define an exterior appearance and has a chamber therein. The scented material is scented and mounted inside the chamber. The stuffing is combined with the scented material, formed by a polyurethane foam material through a foaming process in the chamber, and adhered to an inner wall of the latex body.

A second objective of the present invention is to provide a method for producing the scented stuffed toy.

To achieve the foregoing objective, the method for producing the scented stuffed toy has steps of:

preparing a mold for generating a body of a scented stuffed toy;

injecting molten latex into the mold to form the body having a chamber therein and an orifice therethrough;

filling in the chamber of the body with a polyurethane foam material through the orifice after the body has cooled;

adding a scented material in the chamber to mix with the polyurethane foam material;

performing a foaming process of the polyurethane foam material until the polyurethane foam material is fully foamed in the chamber and adhered to an inner wall of the body; and

removing the mold from the body.

With the addition of the scented material, the stuffing of the scented stuffed toy is mixed with the scented material so as to have the smell of the scented material. Such smell emitted from the stuffing can attract and stimulate pets to chew and play with the stuffed toy with more fun. The method for producing the scented stuffed toy can be easily achieved, featuring the step of adding the scented material to mix with the PU foam material before the foaming process. Accordingly, the scented stuffed toy of the present invention can be luring in emitting a smell to attract pets to chew and play with it with more fun.

### BRIEF DESCRIPTION OF THE DRAWINGS

FIG. 1 is a perspective view in partial section of a first embodiment of a scented stuffed toy in accordance with the present invention;

FIG. 2 is a perspective view in partial section of a second embodiment of a scented stuffed toy in accordance with the present invention;

FIG. 3 is a perspective view in partial section of a third embodiment of a scented stuffed toy in accordance with the present invention;

FIG. 4 is a block diagram of a method for producing a scented stuffed toy in accordance with the present invention; and

FIG. 5 is a perspective view in partial section of a conventional stuffed toy.

### DETAILED DESCRIPTION OF THE INVENTION

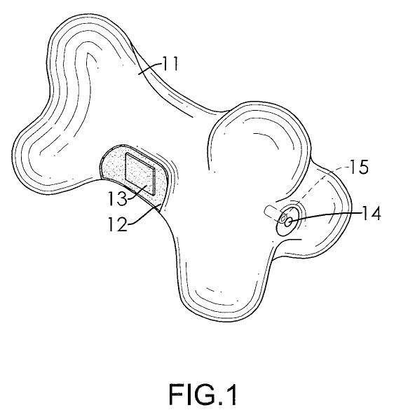

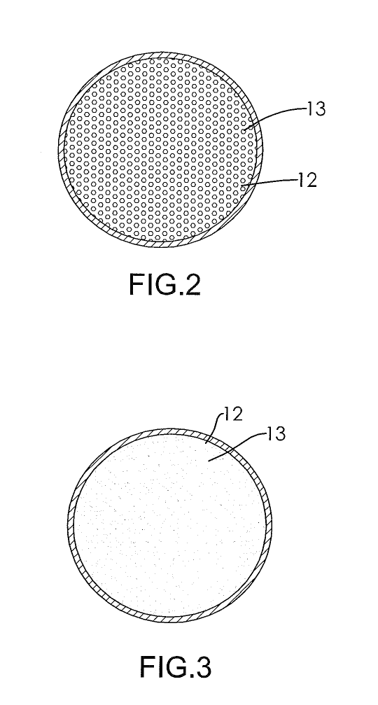

With reference to FIGS. 1 to 3, a scented stuffed toy in accordance with the present invention has a body 11, a stuffing 12, a scented material 13, an orifice 14 and a whistle 15.

The body 11 is formed to define an exterior appearance, has a chamber therein, and may be made of latex. Depending upon the desired entertaining effect, the body 11 may be formed in the shape of an animal, and in other novelty shapes, such as a ball, a vegetable, food or the like. The body 11 in FIG. 1 is shaped as a bone. Due to the nature of being soft and resilient, latex is commonly used as a material to generate a harmless exterior part. The stuffing 12 is formed by a polyurethane (PU) foam material through a foaming process in the chamber and is adhered to an inner wall of the body 11. Because the stuffing 12 is soft and resilient together with the soft and resilient nature of the body 11, the entire stuffed toy is also soft and resilient from inside out. Also because the stuffing 12 formed in the foaming process completely fills the chamber and is also adhered to an inner wall of the body 11, the body 11 and the stuffing 12 are securely bonded.

The scented material 13 is scented, is mounted inside the chamber of the body 11, and is mixed with the PU foam material before the foaming process. Depending on types of pets for which the stuffed toy is made, the scented material 13 may smell like bacon, beef jerky, beef skin, vanilla, mint, vegetable or the like to attract pets. The scented material 13 may be lump-shaped, granular or powder-shaped. With further reference to FIG. 1, when the scented material 13 is lump-shaped, the scented material may be spongy, and is randomly arranged inside the chamber of the body and combined with the stuffing after the foaming process is completed. When the scented material 13 is granular or powder-shaped, the scented material 13 is scattered inside and combined with the stuffing after the foaming process is completed. When the scented material 13 is granular, the grain size of the scented material 13 is in a range of 0.1 mm to 5 mm. When the scented material 13 is powder-shaped, the particle size of the scented material is in a range of 0.001 μm to 0.1 mm. As the scented material 13 is mounted within the stuffing 12, the stuffing 12 can emit a scent as that of the scented material 13.

The orifice 14 is formed through the body 11 for the scent of the scented material to be emitted through. The PU foam material is injected through the orifice 14 into the chamber. The whistle 15 is mounted inside the chamber to align with the orifice 14. When the stuffed toy is squeezed, air inside the chamber is blown through the whistle 15 and the orifice 14 to produce a sound. Due to the scented material mounted inside the body, air blown out through the orifice 14 carries the scent emitted by the stuffing 12 so as to stimulate and lure the sense of smell of pets even more.

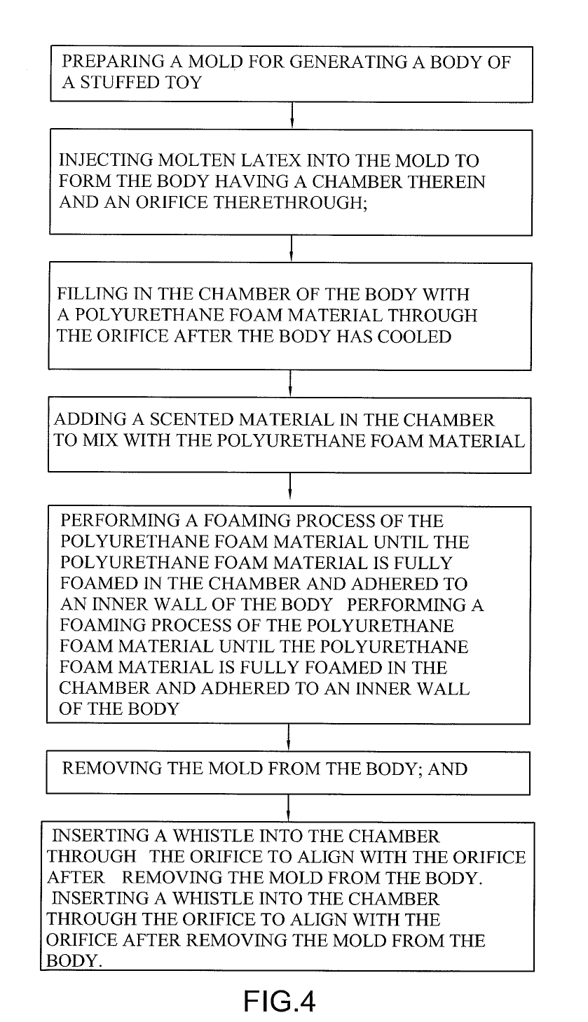

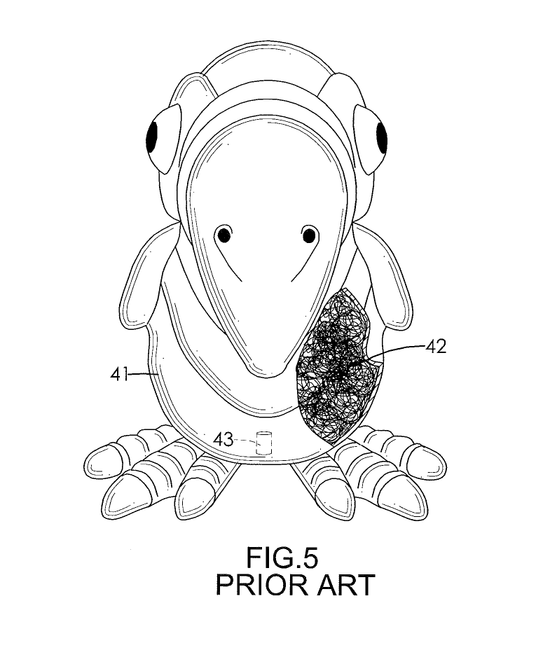

Furthermore, with reference to FIG. 4, a method for producing a scented stuffed toy in accordance with the present invention has steps of:

STEP 1: preparing a mold for generating a body of a stuffed toy;

STEP 2: injecting molten latex into the mold to form the body having a chamber therein and an orifice therethrough;

STEP 3: filling in the chamber of the body with a polyurethane foam material through the orifice after the body has cooled;

STEP 4: adding a scented material in the chamber to mix with the polyurethane foam material;

STEP 5: performing a foaming process of the polyurethane foam material until the polyurethane foam material is fully foamed in the chamber and adhered to an inner wall of the body;

STEP 6: removing the mold from the body; and

STEP 7: inserting a whistle into the chamber through the orifice to align with the orifice after removing the mold from the body.

Due to the scented material added in the body 11 of the stuffed toy and combined with the stuffing 12 in the foaming process, pets can inhale the smell emitted from the stuffing 12 and are lured to chew or play with the stuffed toy with more fun. Depending on the distribution requirement of the scented material, the scented material can be selected from different forms to make the smell of the scented material more concentrated in or evenly spread all over the stuffing 12 inside the body. The method for producing the scented stuffed toy features the step of adding the scented material to mix with the PU foam material before the foaming process. Accordingly, a luring smell can be easily added to the stuffed toy of the present invention to allow the pets to have more fun when playing with the scented stuffed toy.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A scented stuffed toy, comprising:
a latex body formed to define an exterior appearance and having a chamber therein;
a scented material being scented, and mounted inside the chamber; and
a stuffing formed by a polyurethane foam material through a foaming process in the chamber, combined with the scented material, and adhered to an inner wall of the latex body.

2. The scented stuffed toy as claimed in claim 1, further comprising:
an orifice formed through the latex body; and
a whistle mounted inside the chamber to align with the orifice.

3. The scented stuffed toy as claimed in claim 1, wherein the scented material is lump-shaped and is randomly arranged inside the stuffing after the foaming process is completed.

4. The scented stuffed toy as claimed in claim 2, wherein the scented material is lump-shaped and is randomly arranged inside the stuffing after the foaming process is completed.

5. The scented stuffed toy as claimed in claim 1, wherein the scented material is granular and is scattered inside the stuffing after the foaming process is completed.

6. The scented stuffed toy as claimed in claim 2, wherein the scented material is granular and is scattered inside the stuffing after the foaming process is completed.

7. The scented stuffed toy as claimed in claim 5, wherein a grain size of the scented material is in a range of 0.1 mm to 5 mm.

8. The scented stuffed toy as claimed in claim 6, wherein a grain size of the scented material is in a range of 0.1 mm to 5 mm.

9. The scented stuffed toy as claimed in claim 1, wherein the scented material is powder-shaped and is scattered inside the stuffing after the foaming process is completed.

10. The scented stuffed toy as claimed in claim 2, wherein the scented material is powder-shaped and is scattered inside the stuffing after the foaming process is completed.

11. The scented stuffed toy as claimed in claim 9, wherein a particle size of the scented material is in a range of 0.001 μm to 0.1 mm.

12. The scented stuffed toy as claimed in claim 10, wherein a particle size of the scented material is in a range of 0.001 μm to 0.1 mm.

13. A method for producing a scented stuffed toy, comprising steps of:
preparing a mold for generating a body of a scented stuffed toy;
injecting molten latex into the mold to form the body having a chamber therein and an orifice therethrough;
filling in the chamber of the body with a polyurethane foam material through the orifice after the body has cooled;
adding a scented material in the chamber to mix with the polyurethane foam material;
performing a foaming process of the polyurethane foam material until the polyurethane foam material is fully foamed in the chamber and adhered to an inner wall of the body; and
removing the mold from the body.

14. The method for producing a scented stuffed toy as claimed in claim 13 further comprising a step of:
inserting a whistle into the chamber through the orifice to align with the orifice after the step of removing the mold from the body.
